(19) United States
(12) Patent Application Publication
(10) Pub. No.: US 2022/0194425 A1
(43) Pub. Date: Jun. 23, 2022

(54) METHOD FOR OPERATING A VEHICLE CONFIGURED FOR AUTOMATED, IN PARTICULAR HIGHLY AUTOMATED OR AUTONOMOUS DRIVING

(71) Applicant: DAIMLER AG, Stuttgart (DE)

(72) Inventors: Oliver PÖLLNY, Stuttgart (DE); Bianca MIX, Stuttgart (DE)

(21) Appl. No.: 17/610,804

(22) PCT Filed: Apr. 28, 2020
(86) PCT No.: PCT/EP2020/061666

§ 371 Date: Nov. 12, 2021

(30) Foreign Application Priority Data
May 15, 2019 (DE) 10 2019 003 431.7

(51) Int. Cl. B60W 60/00; B60W 30/16

(52) U.S. Cl. CPC B60W 60/0015; B60W 30/16; B60W 2555/20; B60W 2554/4046; B60W 2554/802; B60W 2420/52; B60W 2554/402; B60W 2552/10; B60W 2556/40; B60W 2420/42; B60W 2552/40; B60W 2554/804

(57) ABSTRACT

A method for operating a vehicle configured for highly automated or autonomous driving involves adapting control of the driving mode to the weather conditions of a vehicle's environment. Moreover, control of the driving mode is adapted by reference control parameters if the weather conditions deviate from a specified criterion. For generating the reference control parameters, driving behaviors of a plurality of vehicles in the vehicle's environment, adjacent to the vehicle, are determined. From the determined driving behaviors, an average speed, an average distance, an average acceleration, and an average deceleration are determined and are taken into account when generating the reference control parameters.

### BACKGROUND AND SUMMARY OF THE INVENTION

Exemplary embodiments of the invention relate to a method for operating a vehicle configured for automated, in particular highly automated or autonomous driving.

DE 10 2016 012 774 A1 discloses a method for operating a vehicle capable of autonomous operation in which a vehicle user is offered a number of different driving profiles for selection, wherein as a function of at least one driving profile selected by the vehicle user, a corresponding driving pattern of the vehicle is determined and the vehicle is operated as a function of the driving pattern determined. The driving pattern determined is transmitted wirelessly to road users located in the environment of the vehicle.

Exemplary embodiments of the invention are directed to providing a method that is improved relative to the prior art for operating a vehicle that is configured for automated, in particular highly automated or autonomous driving.

In a method for operating a vehicle configured for automated, in particular highly automated or autonomous driving, control of the driving mode is adapted to the weather conditions around the vehicle.

According to the invention, it is provided that control of the driving mode is then adapted by means of reference control parameters, if the weather conditions deviate from a specified criterion, wherein to generate the reference control parameters, driving behaviors of a plurality of vehicles near and around the vehicle are determined and wherein, from the driving behaviors determined, an average speed, an average distance, an average acceleration, and an average deceleration are determined and are taken into account when generating the reference control parameters.

By means of the method, the driving behavior of the subject vehicle is adapted to the driving behavior of the other vehicles. In particular, the adaptation takes place if it is established that the weather conditions are unfavorable, and if it is further established that other vehicles that are detected by the vehicle in highly automated driving mode are on average driving more defensively than in normal weather conditions. As the vehicle behaves on average corresponding to the other vehicles, the risk of an accident may consequently be reduced significantly. Moreover, regional or cultural characteristics relating to driving behavior may be taken into account by means of the method.

In one embodiment example, in determining driving behaviors, vehicles are taken into account that at various time points are located adjacent to the vehicle in the vehicle's environment. Vehicles are detected that are currently located in the vehicle's environment, as well as vehicles that were located in the vehicle's environment within a specified period in the past. In other words: Vehicles are also taken into account that were detected in the immediate past, but are currently outside a sensing range of the subject vehicle, because, for example, the subject vehicle has overtaken the other vehicle. This increases the efficiency of the method, so that adaptation of the driving behavior is optimized.

In a further embodiment example, a distance threshold value, an acceleration threshold value, and a deceleration threshold value are determined as a function of the average speed. For example, the distance threshold value increases with increasing average speed, whereas the acceleration threshold value or the deceleration threshold value decreases with increasing average speed. The distance threshold value is, in particular, a safety distance that depends on the average speed and is specified as the minimum distance between two vehicles for avoiding an accident, in particular a rear-end collision. For example, the safety distance between two vehicles in the direction of travel is calculated according to the rule of thumb “safety distance=half the speedometer value in meters”, where the average speed is used as the speedometer value.

The threshold values then form a reliable criterion for adapting the control of the driving mode of the subject vehicle, if, for example, the control of the driving mode is then adapted by means of the reference control parameters, if the average distance deviates from the distance threshold value, if the average acceleration deviates from the acceleration threshold value, and/or if the average deceleration deviates from the deceleration threshold value.

Moreover, one embodiment example envisages that the average speed, the average distance, the average acceleration, and/or the average deceleration is or are provided with a correction factor. The correction factor comprises, for example, regional and/or cultural factors, so that a need for safety and comfort can be taken into account as a function of the region. For example, road users in northern latitudes and/or mountainous regions are used to snow-covered and ice-covered roadways and therefore have safer driving behavior in wintry weather conditions compared to road users in southern latitudes and/or lowland regions. The road users with the safer driving behavior will therefore drive less defensively than other, in particular unpracticed road users. The driving behavior of the road users is therefore regionally different, and the method takes these differences into account.

A further embodiment example envisages that classification of the nearby vehicles as a function of vehicle type is carried out. Therefore, it is possible, when determining and analyzing the driving behavior of the other vehicles, for only vehicles to be taken into account that are of the same vehicle type as the subject vehicle. If the subject vehicle is for example a passenger car, only vehicles that are also passenger cars will be taken into account. All other vehicles, e.g., lorries, buses, special vehicles, cyclists and other road users, e.g., pedestrians, are not taken into account when determining and analyzing driving behavior. This allows adaptation of the driving behavior of the subject vehicle to vehicles that are of the same vehicle type. This prevents, for example, the acceleration behavior of the vehicle configured as a passenger car adapting to an acceleration behavior of a lorry or bus, as other passenger cars might perceive this as disturbing.

Further, one embodiment example envisages that when determining driving behavior, exclusively vehicles are taken into account whose vehicle type corresponds to the vehicle type of the subject vehicle and which are in the same lane as the subject vehicle and are in an adjacent lane, the course of which for a specified distance is parallel to the lane of the subject vehicle. For the latter, for example it is verified whether the adjacent lane, within a distance ahead of the vehicle, for example of two kilometers, branches off or is blocked. If this is the case and this does not apply to the subject lane, the vehicles located in this adjacent lane are not taken into account when determining and analyzing the driving behavior.

The course and a state of the adjacent lane may, for example, be determined by means of a map stored in the vehicle or in a data processing unit outside the vehicle, information from a traffic information center, and/or with optical detection of the vehicle's environment. The data processing unit outside the vehicle is, for example, a backend server, which has knowledge of the course and/or state of the adjacent lane by means of vehicle-to-X communication.

Various detected, determined, and/or stored parameters may be employed for determining the weather conditions. In particular, the weather conditions may be determined with a coefficient of friction determined for a road surface, a determined precipitation rate, a detected ambient temperature, a picture of the surroundings detected by means of at least one camera, a radar sensor and/or lidar sensor, and/or information from a weather service outside the vehicle or a traffic management center. The coefficient of friction is, for example, determined and provided by an electronic stability program of the vehicle. The precipitation rate can be detected by a rain sensor or can be determined on the basis of signals detected by a rain sensor. The ambient temperature can be detected by a temperature sensor. Based on the picture of the surroundings detected by the camera, for example, a snow-covered roadway may be recognized, for example based on a very slight contrast between a road pavement and lane markings or unrecognizable lane markings. Data about the surroundings detected by means of radar and/or lidar sensors may also be evaluated correspondingly, as the reflection behavior of a roadway that is not snow-covered differs significantly from that of a snow-covered roadway. Thus, it is possible to determine based on the parameters whether normal weather conditions are present, which excludes a slippery road surface and/or impaired visibility e.g., due to precipitation, or whether unfavorable weather conditions are present, which includes a slippery road surface and/or impaired visibility e.g., due to precipitation.

Furthermore, one embodiment example envisages that conformity of the reference control parameters with the weather conditions is verified continuously. In this case it is verified continually whether the weather conditions have changed and whether consequently adaptation of the control of the driving mode by means of the reference control parameters continues to be required.

Embodiment examples of the invention are explained in more detail hereunder on the basis of drawings.

### BRIEF DESCRIPTION OF THE DRAWING FIGURES

These show:

FIG. 1 schematically, a bird's eye view of the surroundings of a vehicle, with a vehicle and a large number of adjacent vehicles, and

FIG. 2 a flow chart of a method for operating a vehicle driving autonomously.

Parts that are equivalent to one another are given the same reference symbol in all the figures.

### DETAILED DESCRIPTION

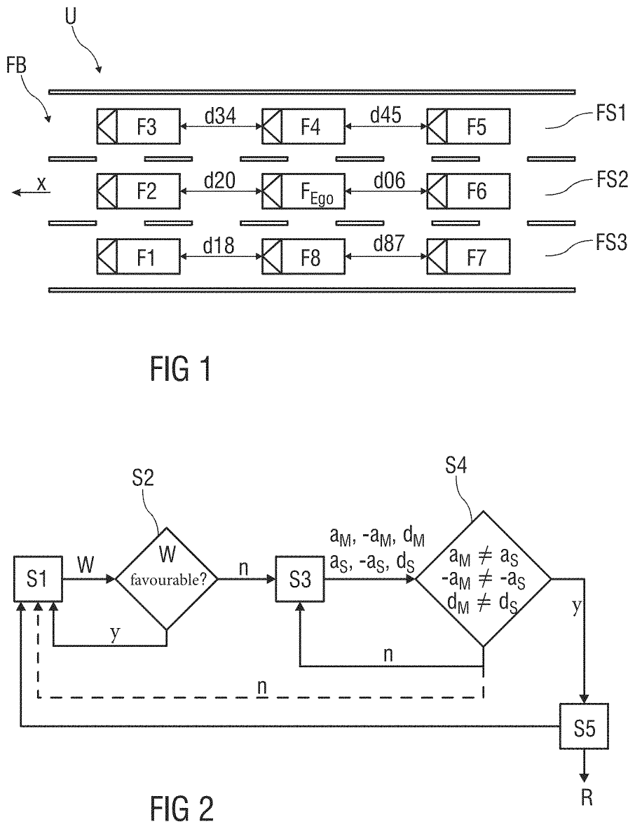

FIG. 1 shows schematically a bird's eye view of the surroundings of a vehicle U.

The surroundings of a vehicle U comprise a roadway FB with three lanes FS1 to FS3, wherein a plurality of vehicles F_{Ego}, F1 to F8 are located on the lanes FS1 to FS3, which move in a direction of travel x along the roadway FB. On a middle lane FS2 there are two vehicles F2, F6 and an “ego vehicle” F_{Ego}, which is designated hereinafter as the subject vehicle F_{Ego}. The subject vehicle F_{Ego} is located between the vehicles F2, F6. On the other lanes FS1, FS3 there are in each case three further vehicles F1, F3 to F5, F7, F8.

The subject vehicle F_{Ego} is configured for an automated, in particular highly automated or autonomous driving mode. Controllable parameters, for example such as a maximum speed, a maximum acceleration and/or deceleration and a minimum distance, are usually configured in such a way that the subject vehicle F_{Ego} can safely manage traffic situations in normal weather conditions W, e.g., with a non-skidding roadway FB and absence of precipitation significantly impairing visibility. In unfavorable weather conditions W, in which, for example, a slippery road surface and/or impairment of visibility due to precipitation prevail, in manual driving mode drivers usually adapt their driving behavior to the prevailing weather conditions W. For example, they reduce their driving speed, maintain a greater distance from road users ahead, and generally decrease driving dynamics. In other words: In unfavorable weather conditions W, drivers drive more defensively than in normal or good weather conditions W.

If in these unfavorable weather conditions W the subject vehicle F_{Ego} is controlled in the highly automated driving mode with the parameters configured for normal weather conditions W, this may possibly be perceived as unreasonable driving behavior by the occupants of the subject vehicle F_{Ego} and/or by other road users. Therefore, a method is proposed, by means of which control of the highly automated driving mode of the subject vehicle F_{Ego} in unfavorable weather conditions W is adapted to the driving behavior of the other vehicles F1 to F8.

In the method described in more detail hereunder, local weather conditions W are determined at the beginning (see FIG. 2). Various detected, determined and/or stored parameters may be employed for determining the weather conditions W. In particular, the weather conditions W may be determined with a determined coefficient of friction of a road surface, a determined precipitation rate, a detected ambient temperature, a picture of the surroundings detected by means of at least one camera, a radar and/or lidar sensor arranged in and/or on the subject vehicle F_{Ego}, and/or information from a weather service outside the vehicle or a traffic management center. The coefficient of friction is, for example, determined and provided by an electronic stability program of the subject vehicle F_{Ego}. The precipitation rate may be detected by a rain sensor mounted on the subject vehicle F_{Ego} or determined based on signals detected by the rain sensor. The ambient temperature can be detected by a temperature sensor of the subject vehicle F_{Ego}. Based on the picture of the surroundings detected by the camera, it may, for example, be recognized whether the roadway FB is snow-covered. This is, for example, recognizable during evaluation of the picture of the surroundings with a very slight contrast between a road pavement and lane markings or unrecognizable lane markings. The surroundings of a vehicle U may also be detected by means of radar and/or lidar sensors mounted on the subject vehicle F_{Ego}. During evaluation of the resultant data about the surroundings, a conclusion about snow covering may be based on the reflection behavior of the roadway FB, as the reflection behavior of the roadway FB changes significantly when there is snow covering, compared to without snow covering.

It is therefore possible to establish, based on the parameters described above, whether normal weather conditions W are present, which excludes a slippery road surface and/or impaired visibility e.g., due to precipitation, or whether unfavorable weather conditions W are present, which includes a slippery road surface and/or impaired visibility, e.g., due to precipitation. In normal weather conditions W, a highly automated driving mode of the subject vehicle F_{Ego} can be regulated and/or controlled independently of the driving behavior of the other vehicles F1 to F8.

In unfavorable weather conditions W, the control of the highly automated driving mode of the subject vehicle F_{Ego} is adapted to the driving behavior of the other vehicles F1 to F8. The control of the highly automated driving mode relates, in particular, to setting of a driving speed, driving dynamics, vehicle acceleration and/or deceleration, and a safety distance.

As the present embodiment example shows, vehicles F1 to F8 adjacent to the subject vehicle F_{Ego}, which are detected by a sensor system (not shown) of the subject vehicle F_{Ego}, are taken into account. The vehicles F1 to F8 may be detected by means of cameras, lidar, and/or radar sensors mounted in and/or on the vehicle F_{Ego}. Moreover, vehicles (not shown) that were detected within a specified period in the past are also taken into account. In other words: The vehicles F1 to F8 are detected that are currently located in the vehicle's environment U, and vehicles that were located in the vehicle's environment U within a specified period in the past. Therefore, vehicles are also taken into account that were detected in the immediate past, but currently are outside of the sensing range of the subject vehicle F_{Ego}, because the subject vehicle F_{Ego} has for example overtaken the other vehicle.

For determining and analyzing driving behavior of the detected vehicles F1 to F8, distances d18, d20, d34, d87, d06, d45 between the vehicles F_{Ego}, F1 to F8 are determined. Moreover, in each case a speed, an acceleration, and a deceleration of the vehicles F1 to F8 are determined. In a fourth step, an average speed is determined from the speeds found. An average acceleration a_{M} (see FIG. 2) is determined from the accelerations found. An average deceleration −a_{M} (see FIG. 2) is determined from the decelerations found. An average distance d_{M} (see FIG. 2) is determined from the distances found d18, d20, d34, d87, d06, d45—excluding the distance d20 between the subject vehicle F_{Ego} and the vehicle ahead F2. In this case median values are formed, in particular as average values. Alternatively, arithmetic mean values may also be formed. The average values are determinable by means of an arithmetic unit (not shown), e.g., vehicle control equipment, which is coupled to the sensor system of the subject vehicle F_{Ego} described above.

A distance threshold value d_{S}, an acceleration threshold value a_{S}, and a deceleration threshold value −a_{S} are determined as a function of the average speed determined (see FIG. 2). For example, the distance threshold value d_{S} increases with increasing average speed, whereas the acceleration threshold value a_{S} or the deceleration threshold value −a_{S} decreases with increasing average speed. The distance threshold value d_{S} is, in particular, a safety distance that depends on the average speed, which is pre-set as the minimum distance between two road users for avoiding an accident, in particular a rear-end collision. For example, the safety distance is determined according to the rule of thumb “safety distance=half the speedometer value in meters”, with the average speed used as the speedometer value.

Moreover, it may be provided that the average speed, the average distance d_{M}, the average acceleration a_{M}, and/or the average deceleration −a_{M} is or are provided with a correction factor. The correction factor comprises, for example, regional and/or cultural factors, so that a need for safety and comfort can be taken into account as a function of the region. For example, road users in northern latitudes and/or mountainous regions are used to snow-covered and ice-covered roadways FB and therefore have safer driving behavior in wintry weather conditions W compared to road users in southern latitudes and/or lowland regions. The road users with safer driving behavior will therefore drive less defensively than other, in particular unpracticed road users. The driving behavior of road users therefore shows regional differences, and the method described here takes these differences into account.

The threshold values described above thus form a reliable criterion for adapting the control of the highly automated driving mode of the subject vehicle F_{Ego}. If the average distance d_{M} deviates from the distance threshold value d_{S}, if the average acceleration a_{M} deviates from the acceleration threshold value a_{S}, and/or if the average deceleration −a_{M} deviates from the deceleration threshold value −a_{S}, it may be concluded that the other vehicles F1 to F8 are on average driving more defensively than in normal weather conditions W. In other words: The drivers of the vehicles F1 to F8 have adapted their driving behavior to the weather conditions W. If this is so, the control of the highly automated driving mode of the subject vehicle F_{Ego} is also adapted to the weather conditions W. If this is not so, no adaptation takes place.

The adaptation of the control of the highly automated driving mode of the subject vehicle F_{Ego} to the weather conditions W takes place by means of reference control parameters R (see FIG. 2). In particular, the control of the highly automated driving mode of the subject vehicle F_{Ego} is adapted to the weather conditions W so that the subject vehicle F_{Ego} copies the driving behavior of a reference vehicle. The reference vehicle is then a fictitious vehicle, which is travelling at a speed corresponding to the average speed determined, and maintains a distance from the car in front corresponding to the average distance d_{M}, and when there is a change in speed, it is accelerated or decelerated at most with the average acceleration a_{M} or the average deceleration −a_{M}. The reference control parameters R therefore comprise the average speed, the average distance d_{M}, the average acceleration a_{M}, and/or the average deceleration −a_{M}. The adaptation to the reference control parameters R then takes place, for example, in the form of a sluggish, technical control process.

For determining and analyzing the driving behavior of the other vehicles F1 to F8, optionally a classification of the vehicles F1 to F8 is undertaken as a function of a vehicle type. It is thus possible that only vehicles F1 to F8 are taken into account that are of the same vehicle type as the subject vehicle F_{Ego}. If, for example, the subject vehicle F_{Ego} is a passenger car, only vehicle types are taken into account that are also passenger cars. All other vehicle types, e.g., lorries, buses, special vehicles, cyclists, and other road users, e.g., pedestrians, are left out of consideration when determining and analyzing the driving behavior. It is thus possible to prevent, for example, an acceleration behavior of the subject vehicle F_{Ego} in the form of a passenger car being adapted to an acceleration behavior of a lorry or bus, as this could be perceived as disturbing by other passenger cars.

Moreover, when determining driving behavior, exclusively vehicles are taken into account that are in the same lane FS2 as the subject vehicle F_{Ego} and that are in an adjacent lane FS1, FS3, the course of which is parallel to the subject lane FS2 for a preset distance, in particular a distance ahead. In this case it is verified, for example, whether the adjacent lane FS1, FS3 branches off or is blocked within a distance ahead of the subject vehicle F_{Ego}, for example of two kilometers. If this is the case and this does not apply to the subject lane FS2, the vehicles F1, F3 to F5, F7, F8 in this adjacent lane FS1, FS3 are not taken into account when determining and analyzing the driving behavior. In a built-up area, in this case for example a distance from a block of buildings may be specified as the distance ahead, provided they are not exclusive turning lanes.

The course and a state of the adjacent lane FS1, FS3 may, for example, be determined with a map stored in the subject vehicle F_{Ego} or in a data processing unit outside the vehicle, information from a traffic information center, and/or with optical detection of the vehicle's environment U. The data processing unit outside the vehicle is, for example, a backend server, which has knowledge of the course and/or state of the adjacent lane FS1, FS3 by means of vehicle-to-X communication.

FIG. 2 shows an example of a flow chart of the method described above.

In a first step S1, the weather conditions W are determined in accordance with the description from FIG. 1.

In a second step S2, it is verified whether the weather conditions W are favorable. If they are favorable, the method is brought back to the first step S1. If the weather conditions W are unfavorable, a third step S3 follows, in which the driving behaviors of the detected vehicles F1 to F8 are determined in accordance with the description from FIG. 1. This comprises determination of the distances d18, d20, d34, d87, d06, d45, speeds, accelerations, and/or decelerations of the vehicles F1 to F8, and formation of the mean values a_{M}, −a_{M}, d_{M} and the threshold values a_{S}, −a_{S}, d_{S}.

In a fourth step S4 it is verified whether the mean values a_{M}, −a_{M}, d_{M} deviate from the threshold values a_{S}, −a_{S}, d_{S}. If the average distance d_{M} deviates from the distance threshold value d_{S}, the average acceleration a_{M} deviates from the acceleration threshold value a_{S}, and/or if the average deceleration −a_{M} deviates from the deceleration threshold value −a_{S}, a fifth step S5 follows. If the mean values a_{M}, −a_{M}, d_{M} do not deviate from the threshold values a_{S}, −a_{S}, d_{S}, the method is brought back to the third step S3 or optionally to the first step S1.

Adaptation of the control of the driving mode of the subject vehicle F_{Ego} by means of the reference control parameters R takes place in the fifth step S5. Furthermore, conformity of the reference control parameters R with the weather conditions W is verified continuously. In particular, it is verified continually whether the weather conditions W have changed and whether in consequence further adaptation of the control of the driving mode by means of the reference control parameters R is required.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method, comprising:
operating a vehicle in an autonomous driving mode;
determining weather conditions of surroundings of the vehicle;
determining whether the determined weather conditions are deviate from a specified criterion; and
adapting the operation of the vehicle in the autonomous driving mode, responsive to determining that the determined weather conditions deviate from the specified criterion, based on reference control parameters,
wherein the reference control parameters are generated based on determined driving behaviors of a plurality of vehicles in an environment of the vehicle, which are adjacent to the vehicle, and
wherein an average speed, an average distance, an average acceleration, and an average deceleration are determined based on the determined driving behaviors and are used to generate the reference control parameters

12. The method of claim 11, wherein the determination of the driving behaviors of the plurality of vehicles accounts for vehicles that are, at various time points, located in the environment of the vehicle adjacent to the vehicle.

13. The method of claim 11, wherein a distance threshold value, an acceleration threshold value, and a deceleration threshold value are determined as a function of the average speed.

14. The method of claim 13, wherein the operation of the vehicle is adapted based on the reference control parameters when the average distance deviates from the distance threshold value, the average acceleration deviates from the acceleration threshold value, or the average deceleration deviates from the deceleration threshold value.

15. The method of claim 11, wherein the average speed, the average distance, the average acceleration, or the average deceleration is adjusted by a correction factor.

16. The method of claim 11, further comprising:
classifying the plurality of vehicles as a function of a vehicle type.

17. The method of claim 16, wherein the determination of the driving behaviors exclusively accounts for vehicles:
having a vehicle type corresponding to a vehicle type of the vehicle being operated in the autonomous driving mode,
that are in a same lane as the vehicle being operated in the autonomous driving mode, and
that are in an adjacent lane, a course of which is parallel to the lane of the vehicle being operated in the autonomous driving mode for a pre-set distance.

18. The method of claim 17, wherein the course and a state of the adjacent lane are determined with a digital map stored in the vehicle, with a digital maps stored in a data processing unit outside the vehicle, information from a traffic information center, or with optical detection of the environment of the vehicle.

19. The method of claim 11, wherein the weather conditions are determined based on:
a determined coefficient of friction of a road surface,
a determined precipitation rate,
a detected ambient temperature,
environmental data detected by at least one camera, a radar, or lidar sensor, or
information from a weather service outside the vehicle or a traffic management center.

20. The method of claim 11, the weather conditions are determined continuously.
